(19) United States
(12) Patent Application Publication
(10) Pub. No.: US 2014/0061101 A1
(43) Pub. Date: Mar. 6, 2014

(54) DEPRESSOR IN IRON ORE FLOTATION COMPRISING SUGAR CANE BAGASSE, USE OF SUGAR CANE BAGASSE AS DEPRESSOR IN IRON ORE FLOTATION AND PROCESS OF PREPARING DEPRESSOR COMPRISING SUGAR CANE BAGASSE

(71) Applicant: VALE S.A., Rio de Janeiro (BR)

(72) Inventors: Marcílio do Carmo Silva, Mariana (BR); Cezar Gonçalves da Silva, Mariana (BR); Flávia Alice Monteiro da Silva Oliveira, Mariana (BR); Elismar Miquelanti, Mariana (BR)

(21) Appl. No.: 14/017,964

(22) Filed: Sep. 4, 2013

Related U.S. Application Data
(60) Provisional application No. 61/696,710, filed on Sep. 4, 2012.

(51) Int. Cl. B03D 1/018; B03D 1/02

(52) U.S. Cl. CPC B03D 1/018; B03D 1/02
USPC 209/166; 252/61

(57) ABSTRACT

A depressor in iron ore flotation comprises sugar cane bagasse and caustic soda so as to assist in the iron ore flotation.

Sugar cane bagasse is used as a depressor in iron ore flotation, and a process of preparing depressor comprising sugar cane bagasse is disclosed.

### STATE OF THE ART

The concentration of minerals occurs when it is necessary to separate the minerals or metals of interest from those which are not. For this separation to occur, the minerals of interest cannot be physically aggregated to those which are not of interest. In such case, it is necessary to perform stages of fragmentation and classification so as to achieve this separation.

To perform the separation of minerals, there must be a physical or physical-chemical difference between the metal of interest and the other components in the mineral and it may be easy or highly complex, depending on the mineral. The most used physical properties in separating or concentrating minerals or metals are the difference in density or difference in magnetic susceptibility. In contrast, when there is no difference in minimal physical property between the minerals or metals that need to be separated, techniques are used based on the physical-chemical properties of the surface of the materials. The most widely used technique in this case is flotation. It is a highly versatile and selective process. It allows concentrates to be obtained that have high contents and significant recoveries. It is usually applied in the processing of minerals with low content and fine granulometry generally in an aqueous suspension. Furthermore, it is possible to use specific reagents, such as collectors, depressors and modifiers, which assist in the selective recovery of the minerals or metals of interest.

Starch is known to be used to assist in iron ore flotation in order to achieve lower iron contents in flotation reject of this mineral.

The present invention discloses a novel depressor to assist the flotation of the iron ore in order to obtain lower iron contents in the reject of said flotation.

### DETAILED DESCRIPTION OF THE DRAWINGS

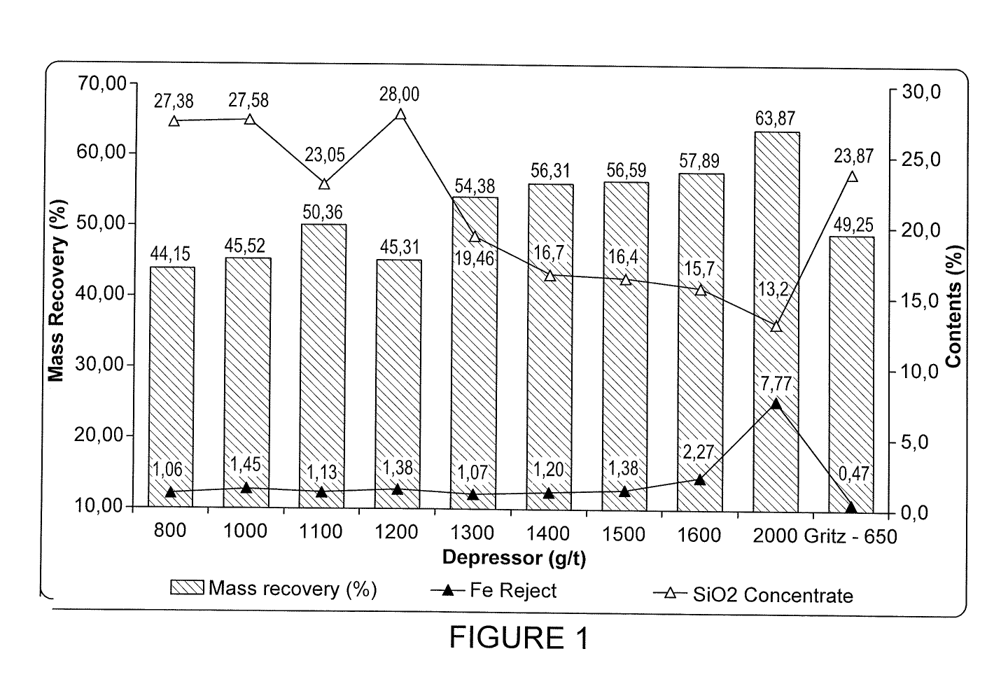

FIG. 1—evolution of the tests with greater depressor dosage.

### DETAILED DESCRIPTION OF THE INVENTION

The present invention refers to a novel depressor to assist in the flotation of iron ore so as to obtain iron contents in the reject of said flotation in accordance with current standards.

More specifically, it refers to the use of sugar cane bagasse as depressor in iron ore flotation.

It further refers to a process of preparing depressor in iron ore flotation that comprises sugar cane bagasse and caustic soda.

Demonstrated below are preferred embodiments of a process of preparing depressor comprising sugar cane bagasse.

The process of preparing a depressor comprising treated sugar cane bagasse comprises the following stages:
a. mixing sugar cane bagasse with water, obtaining a first mixture;
b. adding caustic soda to the mixture above at a ratio of 6:1 to 10:1 part of bagasse: caustic soda, obtaining a second mixture;
c. letting it stand;
d. adding additional water, and
e. agitating

The feed samples of the flotation (mineral) were filtered, homogenized and quartered, separating amounts of 1800 g for each test.

In a first preferred embodiment of the invention, the process of preparing a depressor comprising treated sugar cane bagasse comprises the following stages:
a. mixing 10 grams of the treated sugar cane bagasse with 250 ml of water, obtaining a first mixture;
b. after 5 minutes, adding caustic soda to the mixture above at a ratio of 8:1 part of bagasse: caustic soda, obtaining a second mixture;
c. letting it stand for a further 30 minutes;
d. adding water until reaching 1000 ml, and
e. agitating for a further 10 minutes in an agitator, obtaining the depressor.

The total time for carrying out the process of preparing depressor comprising sugar cane bagasse is similar to the time for preparing an iron ore depressor comprising corn starch.

The depressor comprising sugar cane bagasse was conditioned for 3 minutes and amine (amine solution at 1%) for 1 minute.

The flotation of the iron ore using a depressor comprising sugar cane bagasse was carried out, and the reject was collected from 2 minutes to 2 minutes and 30 seconds.

The tests were carried out according to workbench test standards (flotation until exhaustion). The parameters used for the flotation tests are shown in table 1.

TABLE 1
parameters used in the tests.

| Test | 1 | 2 | 3 | 4 |
|---|---|---|---|---|
| pH | 10.8 | 10.0 | 10 | 10.05 |
| Depressor/ | 500 g/t | 700 g/t | 900 g/t | 1100 g/t |
| bagasse | | | | |
| Amine | 180 g/t | 180 g/t | 180 g/t | 180 g/t |
| | Sio2 | Sio2 | Sio2 | Sio2 |

Chemical results and flotation performance are shown in table 2 below.

TABLE 2
Chemical results.

| IDENTIFICATION | | Fe | SiO2 | P | Al2O3 | Mn | TiO2 |
|---|---|---|---|---|---|---|---|
| Tests 01 - 500 g/t | Concentrate | 66.710 | 1.720 | 0.043 | 0.300 | 0.156 | 0.049 |
| | Reject | 13.890 | 78.280 | 0.013 | 0.490 | 0.046 | 0.001 |
| Tests 01 - 700 g/t | Concentrate | 67.020 | 1.740 | 0.049 | 0.340 | 0.181 | 0.047 |
| | Reject | 21.550 | 67.840 | 0.010 | 0.400 | 0.016 | 0.001 |
| Tests 01 - 900 g/t | Concentrate | 67.050 | 1.250 | 0.047 | 0.310 | 0.172 | 0.047 |
| | Reject | 18.500 | 72.010 | 0.008 | 0.450 | 0.015 | 0.001 |
| Tests 01 - 1100 g/t | Concentrate | 66.670 | 1.910 | 0.045 | 0.340 | 0.161 | 0.039 |
| | Reject | 18.310 | 71.840 | 0.014 | 0.470 | 0.053 | 0.019 |

| IDENTIFICATION | | CaO | MgO | PPC |
|---|---|---|---|---|
| Tests 01 - 500 g/t | Concentrate | 0.011 | 0.018 | 1.70 |
| | Reject | 0.009 | 0.015 | 0.57 |
| Tests 01 - 700 g/t | Concentrate | 0.013 | 0.035 | 1.96 |
| | Reject | 0.006 | 0.043 | 0.30 |
| Tests 01 - 900 g/t | Concentrate | 0.014 | 0.001 | 1.89 |
| | Reject | 0.006 | 0.005 | 0.36 |
| Tests 01 - 1100 g/t | Concentrate | 0.011 | 0.071 | 1.76 |
| | Reject | 0.007 | 0.041 | 0.56 |

TABLE 3
Flotation performance.

| Complementary information | Test 1 | Test 2 | Test 3 | Test 4 |
|---|---|---|---|---|
| Mass recovery | 67.13 | 61.14 | 63.54 | 64.19 |
| Metal recovery | 90.75 | 83.03 | 86.33 | 86.71 |
| Gaudin selectivity index | 14.78 | 11.01 | 14.45 | 11.70 |

Analyzing the results shown in the tables above, the following is concluded:
with the cane bagasse, there was a delay in the discharge of the reject;
the pH used in test 1 (pH 9.5 to 11.0) showed better results of Fe content in the reject (13.89%).

In a second preferred embodiment of the invention, the process of preparing a depressor comprising sugar cane bagasse treated comprises the following stages:
a. mixing 10 grams of the sugar cane bagasse treated with 250 ml of water, obtaining a first mixture;
b. after 5 minutes, adding caustic soda to the mixture above in a ratio of 8:1 part of bagasse: caustic soda, obtaining a second mixture;
c. letting it stand for a further 30 minutes;
d. adding water until reaching 1000 ml, and
e. agitating for a further 10 minutes in a mechanical agitator.

The product of this process is the depressor comprising sugar cane bagasse.

The total time for carrying out the process of preparing depressor comprising sugar cane bagasse is similar to the time for preparing an iron ore depressor comprising corn starch.

Preferably, the preparation of depressor (corn starch or BMC) together with NaOH may comprise the following additional stages:
i. Determining the humidity of the first mixture (sugar cane bagasse) before beginning the first mixture;
ii. Measuring the mass (30 to 40 g) of the material and annotating its value;
iii. Placing the material to dry in a hothouse at a temperature of 105° C. for about 2 hours;
iv. Withdrawing the material from the hothouse,
v. Letting it cool for about 10 minutes,
vi. Measuring the mass of the material stage v;
vii. Annotating the value of the mass after drying and calculating the humidity as follows:

$$UD = ( 1 - \frac{PS}{PU} ) \times 100$$

### Wherein:

UD=humidity of the material−sugar cane bagasse (%)
PS=dry weight of the material−sugar cane bagasse (g)
PU=wet weight of the material−sugar cane bagasse (g)
viii. Calculating the masses: material−sugar cane bagasse and sodium hydroxide using the formulae set forth below:

$${M}_{3} = \frac{{C}_{3} \times {M}_{4}}{100}$$

$${M}_{5} = \frac{{M}_{3}}{100 - U} \times 100$$

$${M}_{6} = \frac{{M}_{3}}{Y} \times 2$$

Wherein:

M₃=dry mass of the material−sugar cane bagasse (g)
C₃=desired concentration of the depressor solution (%)
M₄=desired mass of the depressor solution (g)
M₅=wet mass of the material−sugar cane bagasse (g)
U=humidity of the material−sugar cane bagasse (%)
M₆=mass of caustic soda at 50% (g)
Y=numerator of the ratio sugar cane bagasse/caustic soda
ix. Calculating the masses: gelatinization water and dilution:

M₇=(M₄×0.1)−M₅−M₆

M₈=M₄−M₅−M₆−M₇

### Wherein:

M₇=mass of water for gelatinization at 10% (g)
M_{g}=mass of water for dilution of the solution to the desired concentration (g)
x. Positioning a recipient next to the agitator. If hot water is needed, use the agitator with heater;
xi. Adding gelatinization water (M7) into the recipient and agitate;
xii. Slowing adding the first mixture (M5) into the preparation recipient and wait for about 10 minutes;
xiii. Slowing adding the solution of caustic soda (M6);
xiv. Adjusting the rotation of the agitator so as to maintain the solution homogeneous during gelatinization;
xv. Waiting for about 20 minutes for full gelatinization of the second mixture;
xvi. Adding into the recipient the dilution water (M8) and waiting for about 10 minutes. If the recipient cannot accommodate all the mass, transfer the second mixture to a second recipient with greater capacity;
xvii. Switch off the agitator after 10 minutes;
xviii. Make the second prepared mixture available for use, protecting it from contaminations;
xix. After preparing the second mixture, check its concentration using a refractometer.

The flotation of the iron ore using a depressor comprising sugar cane bagasse was carried out, and the reject collected from 2 minutes to 2 minutes and 30 seconds.

The tests were carried out according to workbench test standards (flotation until exhaustion). The parameters used for the flotation tests are shown in table 1.

The parameters used for the flotation tests are shown in table 4.

| | | Amine | Ratio | | | |
|---|---|---|---|---|---|---|
| | Depressor | EDA-C | Starch/Caustic | pH | pH | Time of |
| Test | (g/t) | (g/t SiO₂) | Soda | Test | Final | Test(s) |
| 01 | Gritz - 650 | 190 | 8:1 | 9.5 | 8.6 | 180 |
| 02 | Gritz - 650 | 190 | 8:1 | 9.5 | 8.5 | 130 |
| 03 | BMC - 650 | 190 | 8:1 | 10.0 | 8.8 | 210 |
| 04 | BMC - 450 | 190 | 8:1 | 9.5 | 8.0 | 120 |
| 05 | BMC - 450 | 190 | 8:1 | 10.0 | 8.7 | 250 |
| 06 | BMC - 450 | 190 | 8:1 | 10.5 | 9.7 | 210 |
| 07 | BMC - 650 | 190 | 8:1 | 9.5 | 7.9 | 150 |
| 08 | BMC - 650 | 190 | 8:1 | 10.0 | 8.9 | 220 |
| 09 | BMC - 650 | 190 | 8:1 | 10.5 | 9.5 | 160 |
| 10 | BMC - 1200 | 190 | 10:1 | 10.5 | 9.3 | 85 |
| 11 | BMC - 2400 | 190 | 10:1 | 10.5 | 9.9 | 90 |
| 12 | BMC - 1200 | 90 | 10:1 | 10.5 | | 120 |
| 13 | BMC - 2400 | 90 | 10:1 | 10.5 | 10.2 | 90 |
| 14 | BMC - 1200 | 90 | 10:1 | 10.5 | 9.8 | 95 |
| | Dry | | | | | |
| 15 | BMC - 2400 | 90 | 10:1 | 10.5 | 10.0 | 96 |
| | Dry | | | | | |
| 16 | BMC - 450 | 90 | 10:1 | 9.5 | 7.9 | 130 |

The tests for evaluating the performance of the depressor are described in the table below.

| | | Mass | | | | | | |
|---|---|---|---|---|---|---|---|---|
| | | recovery | Chemical Analysis (%) | | | | | |
| Test | Flow | (%) | Fe | SiO₂ | P | Al₂O₃ | Mn | TiO₂ |
| 01 | Feed | 100.00 | 45.70 | 33.89 | 0.032 | 0.28 | 0.031 | 0.008 |
| | Concen- | 47.49 | 68.16 | 0.54 | 0.054 | 0.31 | 0.062 | 0.019 |
| | trate | | | | | | | |
| | Reject | 52.51 | 27.08 | 60.56 | 0.012 | 0.34 | 0.007 | 0.001 |
| 02 | Feed | 100.00 | 45.70 | 33.89 | 0.032 | 0.28 | 0.031 | 0.008 |
| | Concen- | 49.25 | 67.86 | 0.47 | 0.052 | 0.33 | 0.059 | 0.016 |
| | trate | | | | | | | |
| | Reject | 50.75 | 23.87 | 64.76 | 0.007 | 0.32 | 0.001 | 0.001 |
| 03 | Feed | 100.00 | 45.70 | 33.89 | 0.032 | 0.28 | 0.031 | 0.008 |
| | Concen- | 16.90 | 66.73 | 0.87 | 0.088 | 0.41 | 0.124 | 0.015 |
| | trate | | | | | | | |
| | Reject | 83.10 | 41.96 | 38.32 | 0.020 | 0.34 | 0.018 | 0.005 |
| 04 | Feed | 100.00 | 45.70 | 33.89 | 0.032 | 0.28 | 0.031 | 0.008 |
| | Concen- | 20.43 | 66.77 | 1.09 | 0.083 | 0.39 | 0.120 | 0.013 |
| | trate | | | | | | | |
| | Reject | 79.57 | 40.49 | 40.77 | 0.017 | 0.31 | 0.006 | 0.006 |
| 05 | Feed | 100.00 | 45.70 | 33.89 | 0.032 | 0.28 | 0.031 | 0.008 |
| | Concen- | 15.83 | 65.68 | 1.06 | 0.088 | 0.46 | 0.134 | 0.015 |
| | trate | | | | | | | |
| | Reject | 84.17 | 42.03 | 39.08 | 0.017 | 0.29 | 0.008 | 0.005 |
| 06 | Feed | 100.00 | 45.70 | 33.89 | 0.032 | 0.28 | 0.031 | 0.008 |
| | Concen- | 12.32 | 65.84 | 0.82 | 0.095 | 0.45 | 0.148 | 0.012 |
| | trate | | | | | | | |
| | Reject | 87.68 | 43.01 | 37.25 | 0.020 | 0.29 | 0.013 | 0.005 |
| 07 | Feed | 100.00 | 45.70 | 33.89 | 0.032 | 0.28 | 0.031 | 0.008 |
| | Concen- | 21.57 | 66.34 | 1.20 | 0.080 | 0.42 | 0.123 | 0.014 |
| | trate | | | | | | | |
| | Reject | 78.43 | 40.10 | 41.56 | 0.016 | 0.30 | 0.004 | 0.005 |
| 08 | Feed | 100.00 | 45.70 | 33.89 | 0.032 | 0.28 | 0.031 | 0.008 |
| | Concen- | 13.46 | 66.11 | 0.75 | 0.096 | 0.43 | 0.149 | 0.012 |
| | trate | | | | | | | |
| | Reject | 86.54 | 42.56 | 37.56 | 0.019 | 0.30 | 0.011 | 0.006 |
| 09 | Feed | 100.00 | 45.70 | 33.89 | 0.032 | 0.28 | 0.031 | 0.008 |
| | Concen- | 14.84 | 65.91 | 0.90 | 0.087 | 0.40 | 0.130 | 0.013 |
| | trate | | | | | | | |
| | Reject | 85.16 | 42.11 | 38.29 | 0.018 | 0.29 | 0.012 | 0.006 |
| 10 | Feed | 100.00 | 45.70 | 33.89 | 0.032 | 0.28 | 0.031 | 0.008 |
| | Concen- | 22.79 | 65.89 | 0.95 | 0.077 | 0.34 | 0.098 | 0.012 |
| | trate | | | | | | | |
| | Reject | 77.21 | 39.56 | 42.03 | 0.015 | 0.33 | 0.009 | 0.003 |
| 11 | Feed | 100.00 | 45.70 | 33.89 | 0.032 | 0.28 | 0.031 | 0.008 |
| | Concen- | 42.05 | 67.35 | 0.87 | 0.056 | 0.28 | 0.069 | 0.016 |
| | trate | | | | | | | |
| | Reject | 57.95 | 29.74 | 57.04 | 0.011 | 0.34 | 0.003 | 0.001 |
| 12 | Feed | 100.00 | 45.70 | 33.89 | 0.032 | 0.28 | 0.031 | 0.008 |
| | Concen- | 45.31 | 66.84 | 1.38 | 0.059 | 0.31 | 0.068 | 0.016 |
| | trate | | | | | | | |
| | Reject | 54.69 | 28.00 | 59.86 | 0.005 | 0.30 | 0.001 | 0.001 |
| 13 | Feed | 100.00 | 45.70 | 33.89 | 0.032 | 0.28 | 0.031 | 0.008 |
| | Concen- | 65.01 | 63.20 | 6.96 | 0.041 | 0.27 | 0.050 | 0.016 |
| | trate | | | | | | | |
| | Reject | 34.99 | 10.92 | 82.58 | 0.004 | 0.36 | 0.001 | 0.001 |
| 14 | Feed | 100.00 | 45.70 | 33.89 | 0.032 | 0.28 | 0.031 | 0.008 |
| | Concen- | 47.22 | 66.85 | 1.55 | 0.054 | 0.31 | 0.066 | 0.018 |
| | trate | | | | | | | |
| | Reject | 52.78 | 26.99 | 60.99 | 0.005 | 0.31 | 0.001 | 0.001 |
| 15 | Feed | 100.00 | 45.70 | 33.89 | 0.032 | 0.28 | 0.031 | 0.008 |
| | Concen- | 67.45 | 60.16 | 11.39 | 0.040 | 0.30 | 0.046 | 0.012 |
| | trate | | | | | | | |
| | Reject | 32.55 | 15.23 | 77.71 | 0.003 | 0.34 | 0.001 | 0.001 |
| 16 | Feed | 100.00 | 45.70 | 33.89 | 0.032 | 0.28 | 0.031 | 0.008 |
| | Concen- | 30.60 | 66.02 | 1.86 | 0.067 | 0.35 | 0.090 | 0.014 |
| | trate | | | | | | | |
| | Reject | 69.40 | 36.39 | 46.58 | 0.009 | 0.29 | 0.001 | 0.001 |

| | | Mass | | | |
|---|---|---|---|---|---|
| | | recovery | Chemical Analysis (%) | | |
| Test | Flow | (%) | CaO | MgO | PPC |
| 01 | Feed | 100.00 | 0.001 | 0.001 | 1.35 |
| | Concentrate | 47.49 | 0.001 | 0.001 | 2.16 |
| | Reject | 52.51 | 0.001 | 0.001 | 0.75 |
| 02 | Feed | 100.00 | 0.001 | 0.001 | 1.35 |
| | Concentrate | 49.25 | 0.001 | 0.001 | 2.15 |
| | Reject | 50.75 | 0.001 | 0.001 | 0.59 |
| 03 | Feed | 100.00 | 0.001 | 0.001 | 1.35 |
| | Concentrate | 16.90 | 0.001 | 0.001 | 3.68 |
| | Reject | 83.10 | 0.001 | 0.001 | 1.09 |
| 04 | Feed | 100.00 | 0.001 | 0.001 | 1.35 |
| | Concentrate | 20.43 | 0.001 | 0.001 | 3.43 |
| | Reject | 79.57 | 0.001 | 0.001 | 0.83 |
| 05 | Feed | 100.00 | 0.001 | 0.001 | 1.35 |
| | Concentrate | 15.83 | 0.001 | 0.001 | 3.72 |
| | Reject | 84.17 | 0.001 | 0.001 | 0.87 |
| 06 | Feed | 100.00 | 0.001 | 0.001 | 1.35 |
| | Concentrate | 12.32 | 0.001 | 0.001 | 4.03 |
| | Reject | 87.68 | 0.001 | 0.001 | 0.95 |
| 07 | Feed | 100.00 | 0.001 | 0.001 | 1.35 |
| | Concentrate | 21.57 | 0.002 | 0.001 | 3.53 |
| | Reject | 78.43 | 0.001 | 0.001 | 0.73 |
| 08 | Feed | 100.00 | 0.001 | 0.001 | 1.35 |
| | Concentrate | 13.46 | 0.001 | 0.001 | 4.02 |
| | Reject | 86.54 | 0.001 | 0.001 | 0.93 |
| 09 | Feed | 100.00 | 0.001 | 0.001 | 1.35 |
| | Concentrate | 14.84 | 0.001 | 0.001 | 3.77 |
| | Reject | 85.16 | 0.001 | 0.001 | 0.90 |
| 10 | Feed | 100.00 | 0.001 | 0.001 | 1.35 |
| | Concentrate | 22.79 | 0.005 | 0.001 | 3.44 |
| | Reject | 77.21 | 0.001 | 0.001 | 0.84 |
| 11 | Feed | 100.00 | 0.001 | 0.001 | 1.35 |
| | Concentrate | 42.05 | 0.001 | 0.001 | 2.58 |
| | Reject | 57.95 | 0.001 | 0.001 | 0.60 |
| 12 | Feed | 100.00 | 0.001 | 0.001 | 1.35 |
| | Concentrate | 45.31 | 0.001 | 0.001 | 2.44 |
| | Reject | 54.69 | 0.001 | 0.001 | 0.48 |
| 13 | Feed | 100.00 | 0.001 | 0.001 | 1.35 |
| | Concentrate | 65.01 | 0.001 | 0.001 | 2.03 |
| | Reject | 34.99 | 0.001 | 0.001 | 0.48 |
| 14 | Feed | 100.00 | 0.001 | 0.001 | 1.35 |
| | Concentrate | 47.22 | 0.001 | 0.001 | 2.38 |
| | Reject | 52.78 | 0.001 | 0.001 | 0.50 |
| 15 | Feed | 100.00 | 0.001 | 0.001 | 1.35 |
| | Concentrate | 67.45 | 0.001 | 0.001 | 1.94 |
| | Reject | 32.55 | 0.001 | 0.001 | 0.54 |
| 16 | Feed | 100.00 | 0.001 | 0.001 | 1.35 |
| | Concentrate | 30.60 | 0.001 | 0.001 | 2.94 |
| | Reject | 69.40 | 0.001 | 0.001 | 0.66 |

It is possible to conclude that the depressor comprising sugar cane bagasse works. Furthermore, it can be noted that the best performance of the flotation, in terms of yield mass and optimum content of SiO₂ in the concentrate, was obtained in test 12, with dosage of BMC (depressor) at 1200 g/t fed, amine dosage at 90 g/t SiO₂, ratio BMC/caustic soda 10:1 and pH 10.5.

Based on this result, new tests were carried out with greater dosages of the depressor and a low dosage of amine 90 g/t SiO₂. The parameters used for the flotation tests are shown in table below.

| | | Amine | | | |
|---|---|---|---|---|---|
| | Depressor | EDA-C | | | Time of |
| Test | (g/t) | (g/t SiO₂) | pH Test | pH Final | Test(s) |
| 01 | 800 | 90 | 10.50 | 9.8 | 120 |
| 02 | 1000 | 90 | 10.50 | 8.9 | 118 |
| 03 | 1100 | 90 | 10.50 | 9.8 | 119 |
| 04 | 1300 | 90 | 10.50 | 9.5 | 121 |
| 05 | 1400 | 90 | 10.50 | 9.8 | 115 |
| 06 | 1500 | 90 | 10.50 | 9.9 | 121 |
| 07 | 1600 | 90 | 10.50 | 9.9 | 122 |
| 08 | 2000 | 90 | 10.50 | 9.9 | 119 |

The table below shows the results obtained with these new parameters:

| | | Mass | | | | | | |
|---|---|---|---|---|---|---|---|---|
| | | recovery | Chemical Analysis (%) | | | | | |
| Test | Flow | (%) | Fe | SiO₂ | P | Al₂O₃ | Mn | PPC |
| 01 | Feed | 100.00 | 45.70 | 33.89 | 0.032 | 0.28 | 0.031 | 1.35 |
| | Concen- | 44.15 | 66.56 | 1.06 | 0.062 | 0.44 | 0.062 | 2.44 |
| | trate | | | | | | | |
| | Reject | 55.85 | 27.38 | 59.79 | 0.008 | 0.39 | 0.001 | 0.48 |
| 02 | Feed | 100.00 | 45.70 | 33.89 | 0.032 | 0.28 | 0.031 | 1.35 |
| | Concen- | 45.52 | 67.20 | 1.45 | 0.058 | 0.44 | 0.065 | 2.44 |
| | trate | | | | | | | |
| | Reject | 54.48 | 27.58 | 60.03 | 0.008 | 0.19 | 0.009 | 0.45 |
| 03 | Feed | 100.00 | 45.70 | 33.89 | 0.032 | 0.28 | 0.031 | 1.35 |
| | Concen- | 50.36 | 67.61 | 1.13 | 0.053 | 0.44 | 0.060 | 2.29 |
| | trate | | | | | | | |
| | Reject | 49.64 | 23.05 | 67.15 | 0.005 | 0.41 | 0.001 | 0.43 |
| 04 | Feed | 100.00 | 45.70 | 33.89 | 0.032 | 0.28 | 0.031 | 1.35 |
| | Concen- | 54.38 | 67.01 | 1.07 | 0.052 | 0.43 | 0.056 | 2.13 |
| | trate | | | | | | | |
| | Reject | 45.62 | 19.46 | 71.51 | 0.004 | 0.47 | 0.001 | 0.45 |
| 05 | Feed | 100.00 | 45.70 | 33.89 | 0.032 | 0.28 | 0.031 | 1.35 |
| | Concen- | 56.31 | 67.06 | 1.20 | 0.051 | 0.44 | 0.054 | 2.02 |
| | trate | | | | | | | |
| | Reject | 43.69 | 16.74 | 74.68 | 0.009 | 0.46 | 0.001 | 0.44 |
| 06 | Feed | 100.00 | 45.70 | 33.89 | 0.032 | 0.28 | 0.031 | 1.35 |
| | Concen- | 56.59 | 67.46 | 1.38 | 0.053 | 0.44 | 0.054 | 2.13 |
| | trate | | | | | | | |
| | Reject | 43.41 | 16.45 | 75.60 | 0.004 | 0.42 | 0.001 | 0.44 |
| 07 | Feed | 100.00 | 45.70 | 33.89 | 0.032 | 0.28 | 0.031 | 1.35 |
| | Concen- | 57.89 | 66.79 | 2.27 | 0.046 | 0.42 | 0.054 | 2.11 |
| | trate | | | | | | | |
| | Reject | 42.11 | 15.79 | 76.26 | 0.003 | 0.43 | 0.001 | 0.45 |
| 08 | Feed | 100.00 | 45.70 | 33.89 | 0.032 | 0.28 | 0.031 | 1.35 |
| | Concen- | 63.87 | 63.36 | 7.77 | 0.043 | 0.40 | 0.049 | 2.00 |
| | trate | | | | | | | |
| | Reject | 36.13 | 13.24 | 79.27 | 0.004 | 0.42 | 0.001 | 0.47 |

| | | Mass | | | | |
|---|---|---|---|---|---|---|
| | | recovery | Chemical Analysis (%) | | | |
| Test | Flow | (%) | TiO₂ | CaO | MgO | PPC |
| 01 | Feed | 100.00 | 0.008 | 0.001 | 0.001 | 1.35 |
| | Concentrate | 44.15 | 0.019 | 0.012 | 0.254 | 2.44 |
| | Reject | 55.85 | 0.001 | 0.008 | 0.215 | 0.48 |
| 02 | Feed | 100.00 | 0.008 | 0.001 | 0.001 | 1.35 |
| | Concentrate | 45.52 | 0.019 | 0.015 | 0.001 | 2.44 |
| | Reject | 54.48 | 0.001 | 0.013 | 0.001 | 0.45 |
| 03 | Feed | 100.00 | 0.008 | 0.001 | 0.001 | 1.35 |
| | Concentrate | 50.36 | 0.018 | 0.017 | 0.001 | 2.29 |
| | Reject | 49.64 | 0.001 | 0.008 | 0.001 | 0.43 |
| 04 | Feed | 100.00 | 0.008 | 0.001 | 0.001 | 1.35 |
| | Concentrate | 54.38 | 0.020 | 0.021 | 0.001 | 2.13 |
| | Reject | 45.62 | 0.001 | 0.019 | 0.001 | 0.45 |
| 05 | Feed | 100.00 | 0.008 | 0.001 | 0.001 | 1.35 |
| | Concentrate | 56.31 | 0.020 | 0.019 | 0.001 | 2.02 |
| | Reject | 43.69 | 0.001 | 0.023 | 0.001 | 0.44 |
| 06 | Feed | 100.00 | 0.008 | 0.001 | 0.001 | 1.35 |
| | Concentrate | 56.59 | 0.020 | 0.026 | 0.001 | 2.13 |
| | Reject | 43.41 | 0.001 | 0.014 | 0.001 | 0.44 |
| 07 | Feed | 100.00 | 0.008 | 0.001 | 0.001 | 1.35 |
| | Concentrate | 57.89 | 0.021 | 0.013 | 0.001 | 2.11 |
| | Reject | 42.11 | 0.001 | 0.012 | 0.001 | 0.45 |
| 08 | Feed | 100.00 | 0.008 | 0.001 | 0.001 | 1.35 |
| | Concentrate | 63.87 | 0.017 | 0.011 | 0.001 | 2.00 |
| | Reject | 36.13 | 0.001 | 0.008 | 0.001 | 0.47 |

It is noted that with the use of lower dosages of amine excellent results were obtained in the quality of the concentrate and mass yield. The tests confirm the use of cane bagasse as a depressor of iron ore in reverse flotation.

1. Process of preparing a depressor in iron ore flotation comprising the following stages:
a. mixing sugar cane bagasse with water, obtaining a first mixture;
b. adding caustic soda to the first mixture at a ratio of 6:1 to 10:1 part of bagasse:caustic soda, obtaining a second mixture;
c. letting the second mixture stand;
d. adding additional water, and
e. agitating.

2. Process of preparing a depressor in iron flotation of claim 1, wherein said ratio between bagasse:caustic soda is preferably 8:1.

3. Process according to claim 1, wherein after 5 minutes caustic soda is added to the mixture at a ratio of 8:1 part of bagasse: caustic soda.

4. Process according to claim 1, wherein in step “c” the second mixture stands for 30 minutes.

5. Process according to claim 1, wherein water is added until reaching 1000 ml.

6. Process according to claim 1, wherein there is agitation for 10 minutes in a mechanical agitator.

7. Process according to claim 1, wherein the pH is between 9.5 and 11.0.

8. Process of preparing a depressor in iron ore flotation according to claim 1, wherein preparation of depressor corn starch or BMC together with NaOH comprises the following steps:
a. determining the humidity of the first mixture (sugar cane bagasse) before beginning the first mixture;
b. measuring the mass of the first mixture;
c. placing the first mixture to dry in a hothouse at a temperature of 105° C. for about 2 hours;
d. withdrawing the first mixture from the hothouse and letting the first mixture cool for about 10 minutes;
e. measuring the mass of the first mixture after removing the first mixture from the hothouse and weighing the first mixture to check a moisture.
f. annotating the value of the mass after drying and calculating the humidity;
g. adding gelatinization water into the recipient and agitating;
h. slowing adding the first mixture into the preparation recipient and waiting for about 10 minutes;
i. slowing adding the solution of caustic soda;
j. adjusting the rotation of the agitator so as to maintain the solution homogeneous during gelatinization;
k. waiting for about 20 minutes for full gelatinization of the second mixture;
l. adding into the recipient the dilution water and waiting for about 10 minutes, wherein if the recipient cannot accommodate all the mass, transfer transferring the second mixture to a second recipient with greater capacity;
m. switching off the agitator after 10 minutes;
n. making the second prepared mixture available for use, protecting the second mixture from contaminations;
o. after preparing the second mixture, checking a concentration using of the second mixture a refractometer.

9. Flotation process wherein a reject is collected from 2 minutes to 2 minutes and 30 seconds in the flotation.

10. A depressor in iron ore flotation comprising sugar cane bagasse and NaOH.

11. A depressor according to claim 10, comprising sugar cane bagasse and NaOH, at a ratio of 6:1 to 10:1 part of sugar cane bagasse:NaOH.

12. A depressor in iron ore flotation obtainable by the process defined in claim 1.

13. Use of sugar cane bagasse for the preparation of a depressor in iron ore flotation.
